(19) United States
(12) Patent Application Publication
(10) Pub. No.: US 2024/0034013 A1
(43) Pub. Date: Feb. 1, 2024

(54) VULCANIZATION MOULD FOR PNEUMATIC VEHICLE TYRES

(71) Applicant: Continental Reifen Deutschland GmbH, Hannover (DE)

(72) Inventors: Nicholas Hoppe, Wunstorf (DE); Jürgen Dzick, Seelze (DE)

(73) Assignee: Continental Reifen Deutschland GmbH, Hannover, OT (DE)

(21) Appl. No.: 18/257,069

(22) PCT Filed: Dec. 9, 2021
(86) PCT No.: PCT/DE2021/200253

§ 371 Date: Jun. 12, 2023

(30) Foreign Application Priority Data
Dec. 11, 2020 (DE) 10 2020 215 768.5

(51) Int. Cl. B29D 30/06; B33Y 80/00; B29C 33/38

(52) U.S. Cl. CPC B29D 30/0606; B33Y 80/00; B29C 33/3842; B29D 2030/0613

(57) ABSTRACT

The invention relates to a vulcanization mold for pneumatic vehicle tires with cast mold segments (1) forming a tread of a pneumatic vehicle tire, which at least have ribs (5, 6) for forming grooves in the tread and sipes (11) for forming incisions in the tread. The invention was based on the object of creating a vulcanization mold of the type described at the outset which, while retaining the inexpensive casting method for the mold segments, enables tread profiles to be formed with grooves and incisions, with the incisions being able to have chamfers in the transition to adjacent blocks in the tread profile and in which the manufacturing limitations described are minimized. This object is achieved in that the elements (5, 6, 11) for producing grooves and incisions are at least partially subsequently introduced into the mold segments (1) after the mold segments (1) have been cast.

The invention relates to a vulcanization mold for pneumatic vehicle tires with cast mold segments forming a tread of a pneumatic vehicle tire, which at least have ribs for forming grooves in the tread and sipes for forming incisions in the tread.

The vulcanization of vehicle tires takes place in heating presses, in each of which a vulcanization mold is used, which has mold segments that shape the tread of the tire with its profile. These mold segments are usually segments of a segment ring and have ribs for forming grooves in the tread, thin sipes are anchored opposite the ribs in the vulcanization mold for forming incisions in the tread. The sipes are usually made of sheet steel, which is stamped, embossed and bent according to the desired design of the incisions in the tread and then anchored in the corresponding mold segment, which is made of an aluminum alloy by casting, during the casting process. The insert casting results in a form fit, not a materially integral bond. In addition, it is also known to produce sipes by selective laser fusion.

In the anchoring sections, sipes designed according to the prior art, regardless of the type of manufacture, usually have holes through which the aluminum alloy of the vulcanization mold segment flows, so that the sipe is fixedly connected to the relevant mold segment after the aluminum alloy has solidified. However, these holes usually do not lead to sufficient stability and anchoring of the sipe in the aluminum alloy of the mold segment, in particular at the end faces of the mold segments.

In order to be able to produce the functional structures of a tread that are required today, separate elements are necessary, as already described, which are usually cast into the basic structure of the cast aluminum mold segments. For manufacturing reasons, these cast-in elements are subject to greater tolerances than directly cast structures. This can be particularly problematic for elements such as tire-shaped ribs, which describe the lowest point in the embossing in the tire profile, because the tolerances are decisive for whether the shape penetrates through the tread compound to the layers underneath and potentially damages them

Even fine structures on the tire surface, such as chamfers, cannot be conjointly cast on the mold base for the elements used, since these chamfers cannot be bonded in a materially integral manner to the element used. Since the sipes usually have a significantly higher strength and different thermal behavior than the base matrix, gaps often form between the sipes and the base matrix, this not meeting the manufacturing requirements for tire vulcanization.

The use of 3D printed elements, taking chamfers into account, is conventionally only possible with inadequate results. For a chamfer to transition seamlessly from the printed part to the cast surface, zero tolerance is required, which is not feasible for reasons of production technology.

DE 10 2018 220 806 A1 discloses sipes which are intended to ensure improved stability of the anchoring of the sipe in the aluminum base structure of the mold segments.

With the solution disclosed in that document, however, the underlying problem of gap formation between sipes made of steel, for example, and the aluminum base structure cannot be eliminated. In particular, chamfers on the incisions in the tread surface cannot be produced with that solution, or can be produced no better than with conventionally designed sipes.

DE 10 2015 202 328 A1 shows a sipe that is produced by a selective laser fusion method. Although complex sipe shapes can be produced therewith, the problem of embedding in the aluminum base matrix of the mold segments is not solved with this type of sipe either.

The invention was based on the object of creating a vulcanization mold of the type described at the outset which, while retaining the inexpensive casting process for the mold segments, enables tread profiles to be formed with grooves and incisions, with the incisions being able to have chamfers in the transition to adjacent blocks in the tread profile and in which the manufacturing limitations described are minimized.

This object is achieved in that the ribs and sipes for producing grooves and incisions are at least partially subsequently introduced into the mold segments after the mold segments have been cast.

The subsequent introduction of the ribs and sipes enables a greatly simplified casting process for the mold segments and a separate, optimized production of the ribs and sipes together with adjacent mold regions. Elements that form chamfers in the tread, for example, can also be introduced into the mold in this way.

In a further refinement of the invention, the mold segments have recesses in predetermined regions, into which separately produced sipes and/or ribs can be inserted.

This arrangement has the advantage that they can be manufactured separately from sipes and/or ribs in an optimized manufacturing process.

In a further refinement of the invention, the recesses in the mold segments have anchoring modules and the sipes and/or ribs have components corresponding to the anchoring modules, with the anchoring modules and the components being intended to ensure a secure retention of the sipes and/or ribs in the recesses when the sipes and/or ribs are inserted into the recess.

In a further refinement of the invention, the sipes and/or ribs have integrally formed, laterally projecting and chamfered elements which, with a predetermined geometry, are suitable for forming chamfers in the transition from the tread surface to incisions or grooves.

By molding the elements producing the chamfers directly onto the sipes and/or ribs, there is no longer any gap in the transition region between the mold segments and the sipes and/or ribs inserted into the recesses.

In a refinement of the invention, a rounding with a predetermined radius is disposed in the outlet of the elements protruding from the sipe and/or rib.

The radius prevents the chamfered elements forming the chamfers from becoming so thin in the run-out that an uncontrolled geometry arises and the elements can break off.

In a refinement of the invention, the sipes and/or ribs are made porous at least in sub-regions.

The porous regions may allow crossventing to function between adjacent blocks.

In a refinement of the invention, the sipes and/or ribs are produced using a 3D printing method.

3D printing methods have the advantage that a large variety of different geometries can be produced easily and in a large variety of materials.

In a refinement of the invention, the sipes and/or ribs are produced by means of a selective laser fusion method.

Particularly high-strength shaped elements can also be produced, in particular by laser fusion process.

Both the 3D printing method and, in particular, the laser fusion method are well suited for seamlessly producing the ribs and sipes mentioned in one piece. A large variety of geometries can be produced by the separate manufacture of the sipes and/or ribs.

An example of the invention will be explained in more detail below on the basis of the drawing. In the drawing:

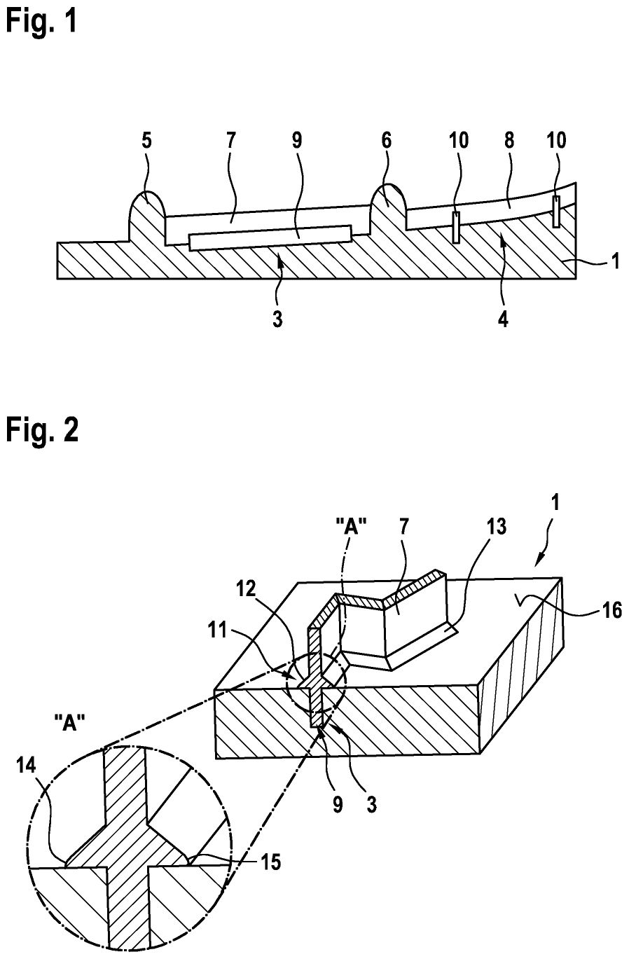

FIG. 1 shows a section of a mold segment of a vulcanization mold according to the invention; and

FIG. 2 shows a fragment of the mold segment with an inserted sipe

FIG. 1 shows a section of a mold segment 1 of a vulcanization mold according to the invention in a schematic cross section. The mold segment 1 is cast from aluminum and has two recesses 3 and 4 and two ribs 5 and 6. The ribs 5 and 6 point into the interior of the vulcanization mold, not shown here, i.e. upward in the drawing position. Two sipes 7 and 8 are disposed in the recesses 3 and 4, shown here in a lateral view.

In the recesses 3 and 4, an anchoring device 9 and 10, not shown in detail, is fixedly connected to the mold segment 1. The anchoring devices interact with the sipes 7 and 8 and couple them firmly to the mold segment 1.

Shown in FIG. 2 is a fragment of a mold segment 1 in a partial section. The recess 3 extends into the mold segment 1 and includes the anchoring device 9, the anchoring device 9 being anchored in the recess 3 here by an interference fit. The sipe 7 is disposed on the anchoring device 9, the anchoring device being integral to the sipe 7. The sipe 7 with the anchoring device 9 are printed integrally from a high-strength and temperature-stable material using a 3D printing method.

In the foot region 11 of the sipe 7 there are oblique transition regions 12 and 13 which are also 3D printed conjointly with the sipe 7 and the anchoring device 9 in one operation. The oblique transition regions 12 and 13 each have a radius in their ends 14 and 15 protruding from the sipe 7, which is visualized in the partial illustration “A”. Due to the fact that the sipe 7 is fixedly connected to the mold segment 1 via the anchoring device 9 and the anchoring device is clamped in the recess 3, the oblique transition regions 12 and 13 lie fixedly on a surface 16 of the mold segment 1, so that a gap formation between the surface 16 and the sipe 7 can be neglected. The sipe 7 creates an incision in a pneumatic vehicle tire tread (not shown here) to be produced with the vulcanization mold, which is bordered by chamfers to be produced by the oblique transition regions 12 and 13 (also not shown).

Because the mold segment 1 is cast from aluminum, it can be produced easily and inexpensively, with the relatively unproblematic ribs 5 and 6 also being integrally cast. 3D printing makes it possible to also produce oblique transition regions 12 and 13 for the sipes 7 and 8 in one operation without the risk of gap formation.

### LIST OF REFERENCE SIGNS

### Part of the Description

1 Mold segment
3, 4 Recesses in the mold segment 1
6 Ribs
7, 8 Sipes
9, 10 Anchoring devices
11 Foot region of the sipe 7
12, 13 Oblique transition regions in the foot region 13 of the sipe 11
14, 15 Radius at the oblique transition regions 12, 13
16 Surface of the mold segment 1

1-6. (canceled)

7. A vulcanization mold for pneumatic vehicle tires, the mold comprising:
a plurality of cast mold segments forming a tread;
a plurality of ribs in the mold segments for forming grooves in the tread;
a plurality of sipes for forming incisions in the tread; and
wherein the ribs and the sipes are introduced into the mold segments subsequently after the casting of the mold segments.

8. The mold of claim 1, wherein the mold segments include a plurality of recesses in predetermined regions into which a plurality of separately produced mold inserts can be inserted, the mold inserts comprising ribs, sipes and other elements forming a chamfer.

9. The mold of claim 8, wherein the recesses in the mold segments have a plurality of anchoring modules and the mold inserts have corresponding components with the anchoring modules, the anchoring modules and the components are to ensure that the mold inserts are held securely in the recesses when the mold inserts are inserted into the recesses.

10. The mold of claim 9, the mold inserts are porous.

11. The mold of claim 10, the mold produced is 3D printed.

12. The mold of claim 8, the mold inserts are produced by a laser fusion.
